(19) United States
(12) Patent Application Publication
(10) Pub. No.: US 2018/0067477 A1
(43) Pub. Date: Mar. 8, 2018

(54) THREE-DIMENSIONAL MODEL PRODUCTION DATA GENERATION APPARATUS, THREE-DIMENSIONAL MODEL PRODUCTION DATA GENERATION NON-TRANSITORY COMPUTER READABLE MEDIUM, THREE-DIMENSIONAL MODEL PRODUCTION DATA GENERATION METHOD, AND THREE-DIMENSIONAL MODEL

(71) Applicant: FUJI XEROX CO., LTD., Tokyo (JP)

(72) Inventors: Naoki HIJI, Kanagawa (JP); Tomonari TAKAHASHI, Kanagawa (JP)

(73) Assignee: FUJI XEROX CO., LTD., Tokyo (JP)

(21) Appl. No.: 15/446,185

(22) Filed: Mar. 1, 2017

(30) Foreign Application Priority Data
Sep. 5, 2016 (JP) 2016-172977

(51) Int. Cl. G05B 19/4099; G06F 17/50

(52) U.S. Cl. CPC G05B 19/4099; G06F 17/50; G06F 2217/12; G05B 2219/49007; G05B 2219/35134

(57) ABSTRACT

A three-dimensional model production data generation apparatus includes: an area setting unit that sets an intersection area as a colored area, the intersection area being obtained when, for each of plural meshes constituting a three-dimensional model, a polygonal prism formed by translating the mesh inwardly of the three-dimensional model is sliced by a slice plane in a predetermined direction; and a color setting unit that sets the color of the colored area set by the area setting unit to the color of the mesh.

### CROSS-REFERENCE TO RELATED APPLICATIONS

This application is based on and claims priority under 35 USC 119 from Japanese Patent Application No. 2016-172977 filed on Sep. 5, 2016.

### BACKGROUND

### Technical Field

The present invention relates to a three-dimensional model production data generation apparatus, a three-dimensional model production data generation non-transitory computer readable medium, a three-dimensional model production data generation method, and a three-dimensional model.

### SUMMARY

When a model material is discharged by an ink-jet to manufacture a three-dimensional model, each of pixels has a flat shape. For this reason, for instance, when the surface of the three-dimensional model is colored in the same color, the concentration of the color of the upper surface and the lower surface may be lighter than the concentration of the color of a lateral surface.

According to an aspect of the invention, there is provided a three-dimensional model production data generation apparatus including: an area setting unit that sets an intersection area as a colored area, the intersection area being obtained when, for each of plural meshes constituting a three-dimensional model, a polygonal prism formed by translating the mesh inwardly of the three-dimensional model is sliced by a slice plane in a predetermined direction; and a color setting unit that sets a color of the colored area set by the area setting unit to a color of the mesh.

### BRIEF DESCRIPTION OF THE DRAWINGS

Exemplary embodiment of the present invention will be described in detail based on the following figures, wherein:

FIG. 1 is a block diagram of a three-dimensional modeling apparatus;

FIG. 2 is a side view of the three-dimensional modeling apparatus;

FIGS. 3A and 3B provide a flowchart of three-dimensional model processing;

FIG. 4 is a view for illustrating a triangular prism;

FIG. 5 is a view for illustrating projection of a texture;

FIG. 6 is a view illustrating an example of a three-dimensional model;

FIG. 7 is a view for illustrating an example of a slice image; and

FIG. 8 is a view for illustrating colored areas.

### DETAILED DESCRIPTION

Hereinafter, an exemplary embodiment for carrying out the present invention will be described in detail with reference to the drawings.

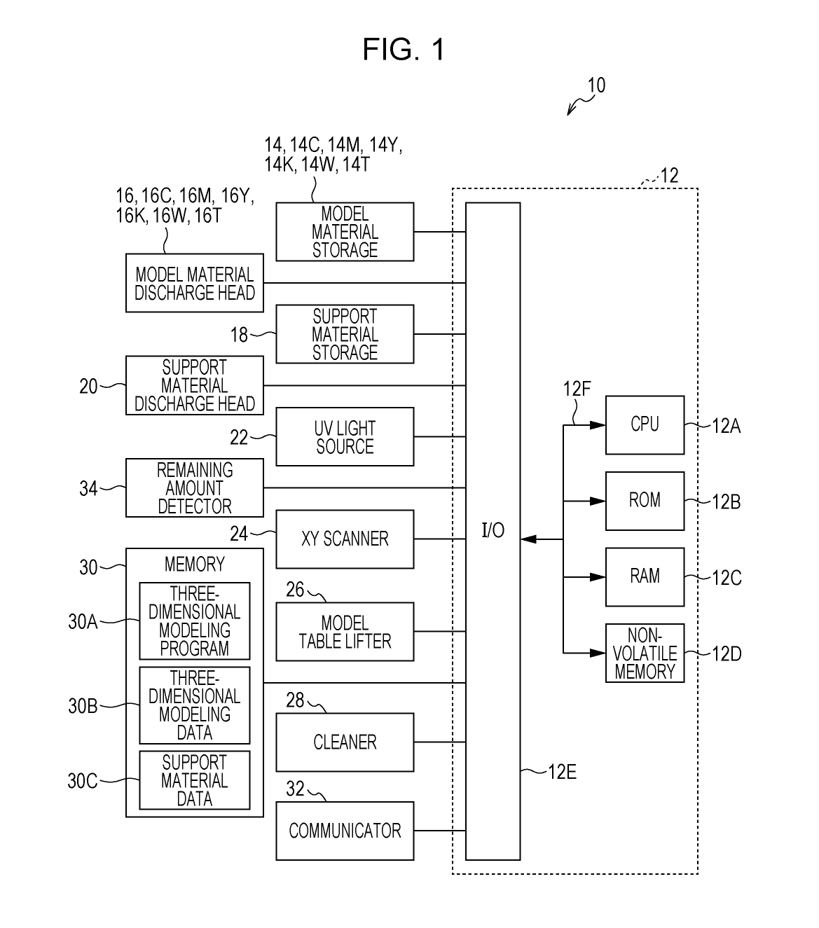

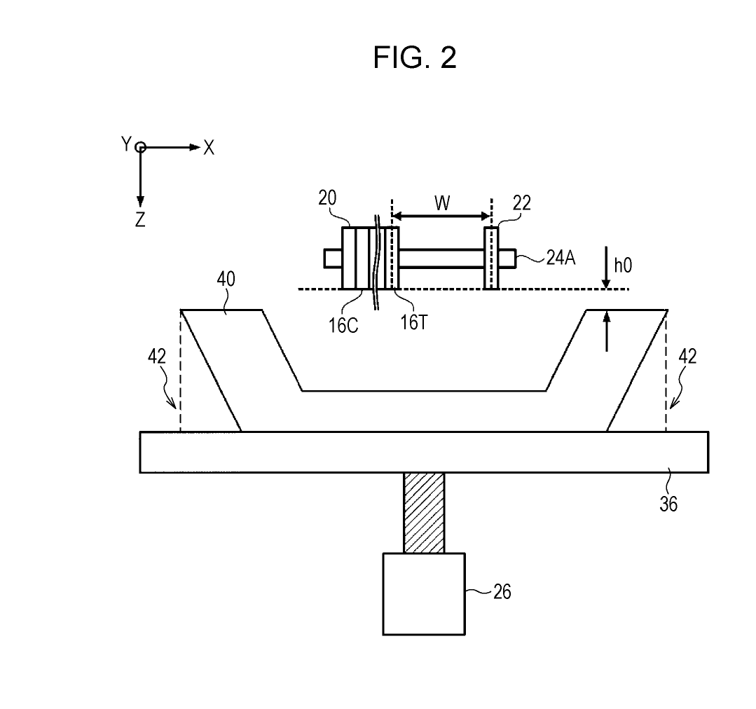

First, the configuration of a three-dimensional modeling apparatus 10 according to this exemplary embodiment will be described with reference to FIG. 1 and FIG. 2. It is to be noted that in the following description, cyan color, magenta color, yellow color, black color, white color, and a transparent color with no tint are denoted by C, M, Y, K, W, and T, respectively, and when components have to be distinguished by color, the end of the symbol of each component is labeled with a color symbol (C, M, Y, K, W, T) corresponding to the color. Also, when components are collectively called without being distinguished by color, the color symbol at the end of each symbol is omitted in the description.

As illustrated in FIG. 1, a three-dimensional modeling apparatus 10 includes a controller 12, model material storages 14C, 14M, 14Y, 14K, 14W, 14T, model material discharge heads 16C, 16M, 16Y, 16K, 16W, 16T, and a support material storage 18. In addition, the three-dimensional modeling apparatus 10 includes a support material discharge head 20, an ultra violet (UV) light source 22, an XY scanner 24, a model table lifter 26, a cleaner 28, a memory 30, a communicator 32, and a remaining amount detector 34.

The controller 12 includes a central processing unit (CPU) 12A, a read only memory (ROM) 12B, a random access memory (RAM) 12C, a non-volatile memory 12D, and an input/output (I/O) interface 12E. The CPU 12A, the ROM 12B, the RAM 12C, the non-volatile memory 12D, and the I/O 12E are connected to each other via a bus 12F.

Also, the I/O 12E is connected to the model material storage 14, the model material discharge head 16, the support material storage 18, the support material discharge head 20, the UV light source 22, and the XY scanner 24. Furthermore, the I/O 12E is connected to the model table lifter 26, the cleaner 28, the memory 30, the communicator 32, and the remaining amount detector 34. It is to be noted that the CPU 12A is an example of an area setting unit, a color setting unit, and a projection unit.

The model material storage 14 stores model materials for creating a three-dimensional model. In addition, the model material storage 14 stores a model material corresponding to each of the colors. The model material is composed of a UV-curing resin or the like that has a property of being cured when irradiated with UV light, that is, ultraviolet light.

The model material discharge head 16 discharges a model material of a corresponding color by ink-jet in accordance with a command from the CPU 12A, the model material being supplied from the model material storage 14.

The support material storage 18 stores a support material for supporting or protecting a three-dimensional model. The support material is used for the purpose of supporting an overhanging portion (a projecting portion) of a three-dimensional model until the three-dimensional model is completed, and is removed after the completion of the three-dimensional model. For instance, when a three-dimensional model has a nearly vertical surface like a cube, the support material is also used for the purpose of avoiding and protecting against liquid dripping on the surface. In addition, the support material is used for the purpose of covering and protecting the model material in order to avoid deterioration of the three-dimensional model due to irradiation of UV light. Similarly to the model material, the support material is composed of a UV-curing resin or the like that has a property of being cured when irradiated with UV light.

The support material discharge head 20 discharges a support material by ink-jet in accordance with a command from the CPU 12A, the support material being supplied from the support material storage 18.

Each of the model material discharge head 16 and the support material discharge head 20 includes plural nozzles, and uses a piezoelectric type discharge head that discharges droplets of each material by pressure. As long as each discharge head is of inkjet type, the discharge head is not limited to the piezoelectric type and may be a type of discharge head in which each material is discharged by the pressure of a pump.

The UV light source 22 irradiates the model material discharged from the model material discharge head 16 and the support material discharged from the support material discharge head 20 with UV light to cure the materials. The UV light source 22 is selected according to the type of the model material and the support material. As the UV light source 22, for instance, a metal halide lamp, a high-pressure mercury lamp, an ultra-high pressure mercury lamp, a deep ultraviolet lamp, a mercury lamp which is excited from the outside without an electrode using microwave, an ultraviolet laser, a xenon lamp, or a device having a light source such as an UV-light emitting diode (LED) may be used. Furthermore, instead of the UV light source 22, an electron beam irradiation device may be used. As an electron beam irradiation device, for instance, a scanning-type, a curtain-type, and a plasma discharge type electron beam irradiation devices may be listed.

As illustrated in FIG. 2, the model material discharge head 16, the support material discharge head 20, and the UV light source 22 are mounted on a scanning shaft 24A included in the XY scanner 24.

The model material discharge head 16 (the model material discharge head 16T in the example of FIG. 2) disposed nearest to the UV light source 22, and the UV light source 22 are mounted on the scanning shaft 24A with a predetermined distance W spaced apart from each other. Also, the support material discharge head 20 adjacent to the model material discharge head 16 is mounted on the scanning shaft 24A. It is to be noted that the order of arrangement of the model material discharge head 16 and the support material discharge head 20 is not limited to the example illustrated in FIG. 2, and may be the other order of arrangement.

The XY scanner 24 drives the scanning shaft 24A so that the model material discharge head 16, the support material discharge head 20, and the UV light source 22 move in the X-axis direction and the Y-axis direction, in other words, scan the XY plane.

The model table lifter 26 moves up and down a model table 36 illustrated in FIG. 2 in the Z-axis direction. The CPU 12A controls the model material discharge head 16, the support material discharge head 20, and the UV light source 22 so that when a three-dimensional model is created, the model material and the support material are discharged onto the model table 36, and the discharged model material and support material is irradiated with UV light. The CPU 12A controls the XY scanner 24 so that the model material discharge head 16, the support material discharge head 20, and the UV light source 22 scan the XY plane, as well as controls the model table lifter 26 so that the model table 36 is gradually lowered in the Z-axis direction.

It is to be noted that when a three-dimensional model is created, in order to avoid contact between the model material discharge head 16, the support material discharge head 20, the UV light source 22, and a three-dimensional model 40 on the model table 36, the CPU 12A controls the model table lifter 26 so that the distance between the model material discharge head 16, the support material discharge head 20, the UV light source 22, and the three-dimensional model 40 on the model table 36 in the direction of the Z-axis is greater than or equal to a predetermined distance h0.

The cleaner 28 has the function of cleaning the nozzles of the model material discharge head 16 and the support material discharge head 20 by sucking material adhering to the nozzles. For instance, the cleaner 28 is provided in a retreat area outside a scan range of the model material discharge head 16 and the support material discharge head 20, and when cleaning is performed, the model material discharge head 16 and the support material discharge head 20 are retreated to the above-mentioned retreat area before cleaning.

The memory 30 stores the later-described three-dimensional modeling program 30A, three-dimensional modeling data 30B, and support material data 30C. The CPU 12A reads and executes the three-dimensional modeling program 30A stored in the memory 30. It is to be noted that by using a CD-ROM drive or the like, the CPU 12A may read and execute the three-dimensional modeling program 30A recorded on a recording medium such as a compact disk read only memory (CD-ROM). Also, the CPU 12A may read the three-dimensional modeling program 30A from an external device via a network to execute the three-dimensional modeling program 30A.

As the format for the three-dimensional modeling data 30B according to this exemplary embodiment, for instance, OBJ format is used which is a format for data that represents the shape and color of a three-dimensional model. In the OBJ format, an OBJ file that deals with data of geometric shapes, and an MTL file that deals with material data including color information and texture information are used. In this exemplary embodiment, the three-dimensional model 40 is represented by a set of triangular meshes, as an example. In the OBJ file, for each mesh, the face number specific to the mesh and the coordinate data of the vertices of the triangular mesh are defined in an associated manner. Also, in the MTL file, color information and texture (pattern) information are defined in association with each mesh. It is to be noted that the format of data representing a three-dimensional model is not limited to the OBJ format, and may be another format.

The communicator 32 is an interface for performing data communication with an external device that outputs the three-dimensional modeling data 30B for a three-dimensional model. The CPU 12A creates a three-dimensional model by controlling each of components in accordance with the three-dimensional modeling data 30B transmitted from the external device.

The remaining amount detector 34 detects the remaining amount of the model material stored in each model material storage 14 individually using an optical sensor, for instance.

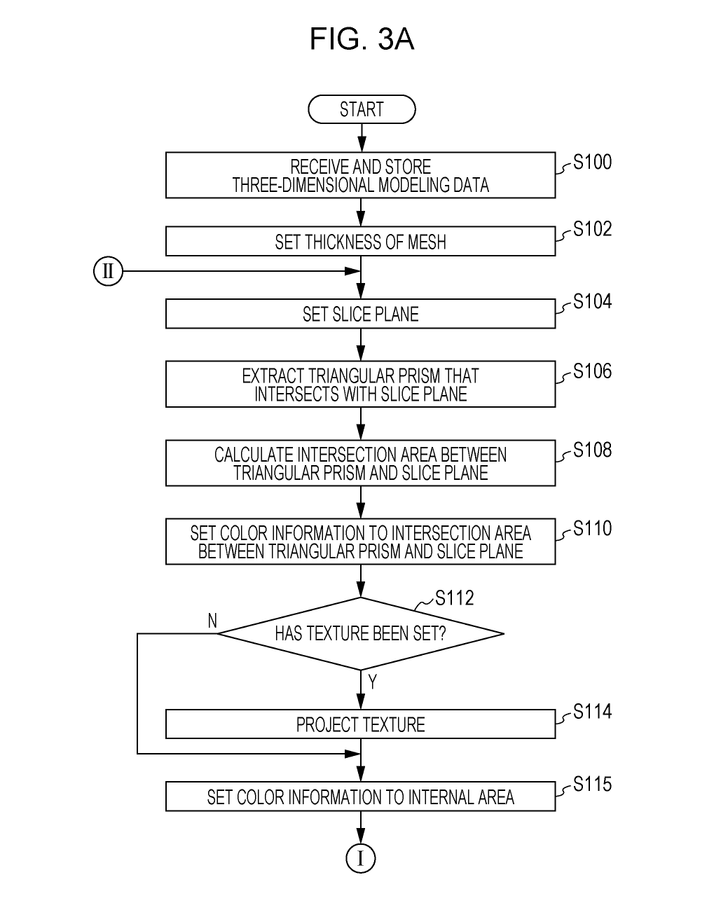

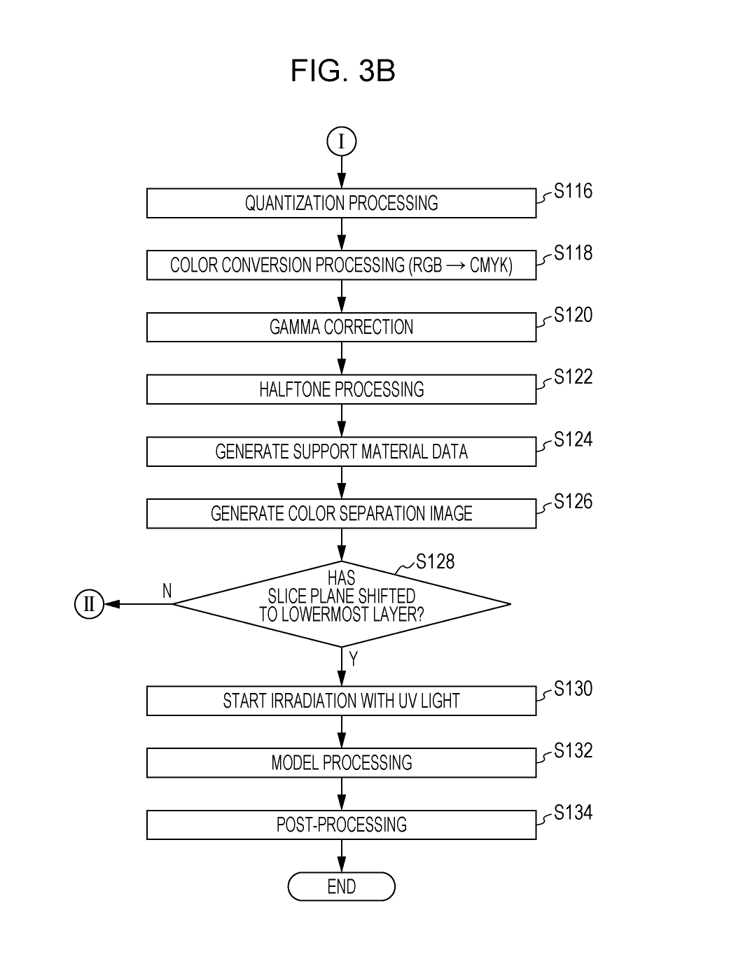

Next, the operation of the three-dimensional modeling apparatus 10 according to this exemplary embodiment will be described with reference to FIGS. 3A and 3B. The CPU 12A executes the three-dimensional modeling program 30A, thereby performing the three-dimensional model processing illustrated in FIGS. 3A and 3B. It is to be noted that the three-dimensional model processing illustrated in FIGS. 3A and 3B is executed, for instance, when a command to start creating a three-dimensional model is received from an external device.

In step S100 of FIG. 3A, the three-dimensional modeling data 30B for a three-dimensional model is received from an external device, and stored in the memory 30.

In step S102, the OBJ file is referred, and for each of the meshes that define the shape of the three-dimensional model, an inner thickness d of the three-dimensional model in the normal direction to the mesh is set. Specifically, each mesh is translated by the thickness d in the normal direction inwardly of the three-dimensional model to form a triangular prism, and the coordinate data of six vertices of the triangular prism is stored in the memory 30. For instance, as illustrated in FIG. 4, a mesh 50 is translated by the thickness d in the normal direction H inwardly of the three-dimensional model to form a triangular prism 52, and the coordinate data of the six vertices 52-1 to 52-6 of the triangular prism 52 is stored in the memory 30. This processing is performed for all meshes.

It is to be noted that the thickness d is preset to a thickness that does not cause a difference in color concentration depending on the position of a mesh, for instance when the three-dimensional model is colored in the same color.

In step S104, a slice plane parallel to a contact plane (XY plane) on which the three-dimensional model is in contact with the model table 36 is set. At first, a slice plane is set, for example, to the top layer of the three-dimensional model. Also, when step S102 is performed after a negative determination is made in the later-described step S128, a slice plane is set to a plane shifted to a lower layer by a predetermined layer pitch (distance) p. It is to be noted that hereinafter the position of the set slice plane in the Z-axis direction is denoted by a pitch No. For instance, the pitch No. of the top layer is “1”, and each time the slice plane is shifted to a lower layer by the layer pitch p, the pitch No. is incremented.

In step S106, the coordinate data of triangular prisms calculated in step S102 is referred to, and each triangular prism is extracted, which intersects with the slice plane set in step S104 when the three-dimensional model is sliced by the slice plane.

In step S108, for each of all the triangular prisms extracted in step S106, an intersection area obtained by slicing the triangular prism with the slice plane set in step S102 is calculated based on the coordinate data of all the triangular prisms determined in step S106.

In step S110, color information is set to each intersection area calculated in step S108. For instance, for the triangular prism 52 of FIG. 4, when the triangular prism 52 is sliced by the slice plane, an intersection area 54 indicated by hatching is determined. The MTL file is then referred to, and the color information set to the mesh 50 is set (copied) to the intersection area 54.

Specifically, in the case of the intersection area 54 of FIG. 4, slice data is stored in the memory 30, the slice data in which the pitch No. of the slice plane set in step S102, the coordinate data of four vertices 54-1 to 54-4 of the intersection area 54, and the color information set to the mesh 50 are associated with one another. This processing is performed for all the meshes extracted in step S106.

In step S112, the MTL file is referred to, and it is determined whether or not a texture has been set to the mesh extracted in step S106. When a texture has been set, the flow proceeds to step S114, and when a texture has not been set, the flow proceeds to step S115.

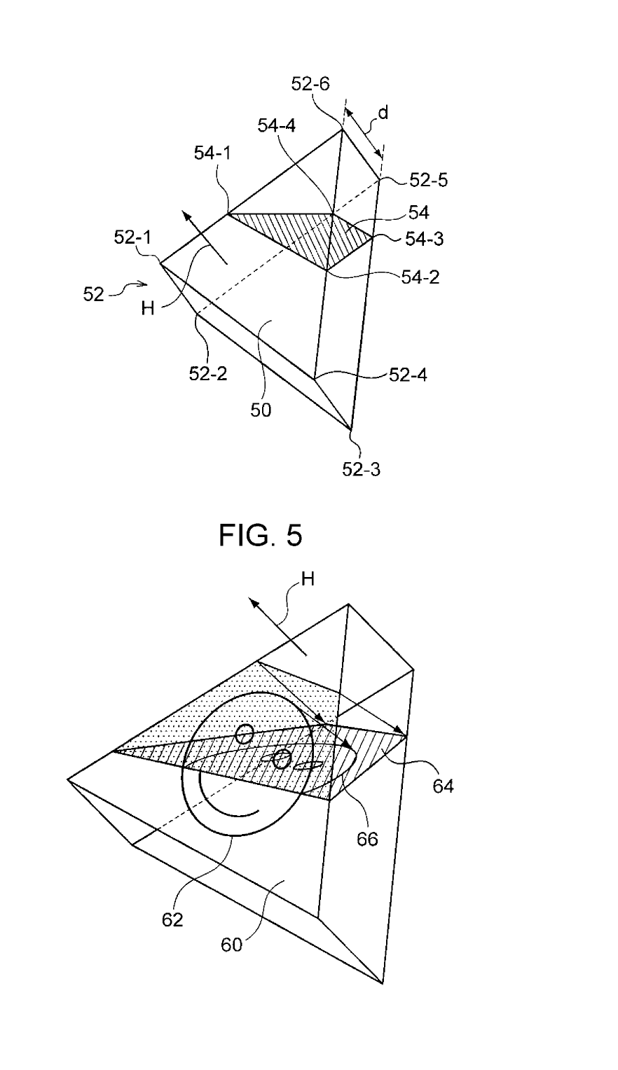

In step S114, the MTL file is referred to to obtain texture information, and the texture is projected on the intersection area based on the obtained texture information. Specifically, when a texture 62 is set to the mesh 60 as illustrated in FIG. 5, the texture 62 is projected toward the intersection area 64 in the normal direction H to the mesh 60. Thus, the texture 66 is projected on the intersection area 64.

In step S115, color information is set to the internal area other than the colored areas, inwardly of the three-dimensional model 70. In this exemplary embodiment, white color is set as an example.

In step S116, a slice image based on the slice data stored in the memory 30 in step S110 is quantized using a publicly known technique, and RGB slice image data is generated.

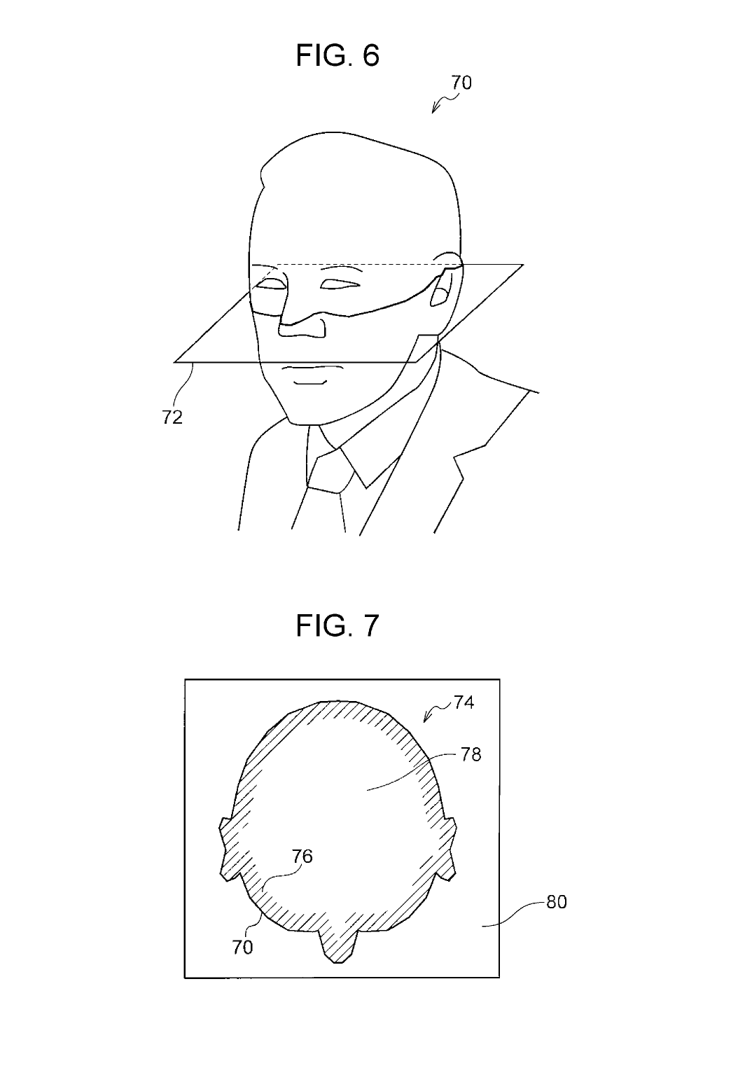

Here, for instance, in the case where a three-dimensional model to be created is the three-dimensional model 70 which is the head of a person as illustrated in FIG. 6, when the three-dimensional model 70 is sliced by a slice plane 72, a slice image 74 as illustrated in FIG. 7 is obtained. In this case, although the intersection area between the three-dimensional model 70 and the slice plane 72 is set as a colored area 76 indicated by hatching, white color is set to an internal area 78 other than the colored area 76, inwardly of the three-dimensional model 70. For instance, when the slice image is quantized with 8 bits for each of RGB, the pixel value of each pixel in the internal area 78 is set such that R=G=B=255. Also, a transparent (Alpa) value is set to each pixel in an external area 80 which is outwardly of the three-dimensional model 70 and in which no substance exists.

In step S118, the RGB slice image data quantized in step S116 is converted to CMYK slice image data using a publicly known technique.

In step S120, gamma correction processing is performed on the CMYK slice image data generated in step S118, using a publicly known technique.

In step S122, halftone processing is performed on the CMYK slice image data gamma-corrected in step S120 using a publicly known technique.

In step S124, the support material data 30C is generated. A three-dimensional model is created by successively layering the model material on the model table 36. When a portion of the three-dimensional model has a space therebelow, that is, so-called an overhanging portion is present, the overhanging portion has to be supported from a lower position. For this reason, a support portion, which is a space below the overhang portion, is identified based on the slice data of the adjacent layer immediately above the layer which is the current target for processing, and the support material data 30C is generated. For instance, in the case of the three-dimensional model 40 as illustrated in FIG. 2, the space below an overhang portion is identified as a support portion 42, and the support material data 30C is generated, which indicates that the support material is to be discharged to the support portion 42.

Specifically, in the adjacent layer immediately above the layer which is the current target for processing, an area in which a three-dimensional model is present or an area for which the support material is determined to be necessary, in other words, the same area on the XY plane as the area, in which the model material or the support material is present, is identified as the support portion for which the support material is necessary for supporting the area in which the material of the upper layer is present. The support material data 30C is then generated, which indicates that the support material is to be discharged to the support portion.

In step S126, color separation image for each color is generated in the Tagged Image File Format (TIFF) format based on the CMYK slice image data generated in step S118. It is to be noted that the format of image may be other than the TIFF format.

In step S128, it is determined whether or not the slice plane has been shifted to the lowermost layer. When the slice plane is determined to be shifted to the lowermost layer, the flow proceeds to step S130, and when the slice plane is determined to be not shifted to the lowermost layer, in other words, when an unprocessed slice plane is present, the flow proceeds to step S104, and the slice plane is shifted to a lower layer by the layer pitch p, and the same processing as described above is performed.

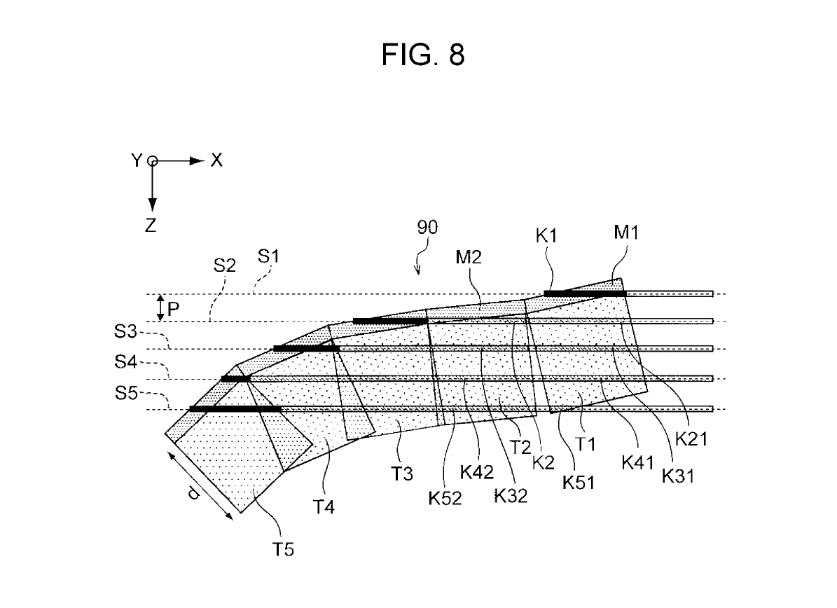

Here, a specific example of a range of colored area will be described with reference to FIG. 8. As illustrated in FIG. 8, when a three-dimensional model 90 is sliced by a slice plane S1, a colored area colored in the color of a mesh M1 is given by an intersection area K1 between the slice plane S1 and a triangular prism T1 formed by translating the mesh M1 in the normal direction to the mesh M1 by the thickness d.

Also, when a three-dimensional model 90 is sliced by a slice plane S2, a colored area colored in the color of a mesh M2 is given by an intersection area K2 between the slice plane S2 and a triangular prism T2 formed by translating the mesh M2 in the normal direction to the mesh M2 by the thickness d. Since the slice plane S2 intersects with the triangular prism T1, an intersection area K21 between the triangular prism T1 and the slice plane S2 is also a colored area colored in the color of the mesh M1.

Thus, the intersection areas K1, K21, K31, K41, and K51 obtained when the triangular prism T1 is sliced by the slice planes S1 to S5 are colored areas colored in the color of the mesh M1. In addition, the intersection areas K2, K32, K42, and K52 obtained when the triangular prism T2 is sliced by the slice planes S2 to S5 are colored areas colored in the color of the mesh M2.

It is to be noted that the same goes with the cases of the intersection areas obtained when a triangular prism T3 formed by translating a mesh M3 in the normal direction to the mesh M3 by the thickness d is sliced by the slice planes S2 to S5, the intersection areas obtained when a triangular prism T4 formed by translating a mesh M4 in the normal direction to the mesh M4 by the thickness d is sliced by the slice planes S3 to S5, and the intersection areas obtained when a triangular prism T5 formed by translating a mesh M5 in the normal direction to the mesh M5 by the thickness d is sliced by the slice planes S4 and S5.

In this manner, the colored areas are provided inwardly of the three-dimensional model 90, thereby reducing a difference in color concentration depending on the position of a plane when the three-dimensional model is colored in the same color.

In step S130, the UV light source 22 is controlled to start irradiation with UV light.

In step S132, model processing is performed. Specifically, the XY scanner 24 is controlled so that the model material discharge head 16 and the support material discharge head 20 scan the XY plane, and the model table lifter 26 is controlled so that the model table 36 is gradually lowered in the Z-axis direction. Along with this control, the model material discharge head 16 is controlled so that the model material is discharged in accordance with the TIFF data for each color generated in step S126, and the support material discharge head 20 is controlled so that the support material is discharged in accordance with the support material data 30C generated in step S124.

In step S134, predetermined post-processing is performed, such as processing of stopping irradiation with UV light started in step S130, and processing of cleaning the model material discharge head 16 and the support material discharge head 20. It is to be noted that the processing of cleaning may be performed at predetermined timing, for instance, every elapse of a predetermined period or every time when a predetermined amount of at least one of the model material and the support material is consumed. When the processing in step S134 is completed, the three-dimensional model processing is completed.

In this manner, in this exemplary embodiment, an intersection area between a slice plane and a triangular prism having a thickness in the normal direction to a mesh is colored in the color of the mesh. Consequently, a three-dimensional model that has a predetermined thickness inwardly in the normal direction to a mesh and that is colored in the color of the mesh is produced, thereby reducing a difference in color concentration depending on the position of a plane when the three-dimensional model is colored in the same color.

It is to be noted that in this exemplary embodiment, the case has been described in which when a triangular prism is formed by giving a thickness to a mesh, the thickness d is a fixed value. However, the thickness d may be set according to the concentration of color information set to the mesh. For instance, the thickness d may be set to be thicker as the concentration of color information on the mesh increases. This avoids unnecessary coloring of the inside of a three-dimensional model.

Also, in the case where a texture is set to each mesh, when the set texture is well defined, the thickness d is set to be thinner.

In this exemplary embodiment, the case has been described in which the further inside of the colored areas inwardly of a three-dimensional model is set to white color. However, the inside may be colored in another color. In the case of setting another color, the thickness d is set to be thicker compared with the case of setting white color.

In this exemplary embodiment, the case has been described in which the shape of each mesh is a triangle. However, without being limited to this, the mesh may be a polygon having more sides than a quadrilateral.

In this exemplary embodiment, an inkjet type three-dimensional modeling apparatus has been described. However, without being limited to this, the present invention may be applied to a thermal fusion type three-dimensional modeling apparatus.

Although the case has been described in which the model table 36 is gradually lowered in the Z-axis direction while the XY plane is being scanned by the model material discharge head 16 in the aforementioned exemplary embodiment, the model table 36 may be fixed and the model table 36 may be gradually raised in the Z-axis direction while the XY plane is being scanned by the model material discharge head 16.

Also, the configuration of the three-dimensional modeling apparatus 10 (see FIG. 1) described in the aforementioned exemplary embodiment is an example, and it goes without saying that an unnecessary portion may be eliminated or a new portion may be added within a scope not departing from the spirit of the present invention.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A three-dimensional model production data generation apparatus comprising:
an area setting unit that sets an intersection area as a colored area, the intersection area being obtained when, for each of a plurality of meshes constituting a three-dimensional model, a polygonal prism formed by translating the mesh inwardly of the three-dimensional model is sliced by a slice plane in a predetermined direction; and
a color setting unit that sets a color of the colored area set by the area setting unit to a color of the mesh.

2. The three-dimensional model production data generation apparatus according to claim 1, further comprising
a projection unit that, when a texture is set to the mesh, projects the texture on the intersection area.

3. The three-dimensional model production data generation apparatus according to claim 1,
wherein the area setting unit sets a thickness of the polygonal prism to a fixed thickness.

4. The three-dimensional model production data generation apparatus according to claim 2,
wherein the area setting unit sets a thickness of the polygonal prism to a fixed thickness.

5. The three-dimensional model production data generation apparatus according to claim 1,
wherein the area setting unit increases a thickness of the polygonal prism as a concentration of the color of the mesh increases.

6. The three-dimensional model production data generation apparatus according to claim 2,
wherein the area setting unit increases a thickness of the polygonal prism as a concentration of the color of the mesh increases.

7. A non-transitory computer readable medium storing a program causing a computer to function as each unit of the three-dimensional model production data generation apparatus according to claim 1.

8. A three-dimensional model comprising a plurality of meshes,
wherein each of the meshes is colored with a predetermined thickness inwardly in a normal direction to the mesh.

9. A three-dimensional model production data generation method comprising:
setting an intersection area as a colored area, the intersection area being obtained when, for each of a plurality of meshes constituting a three-dimensional model, a polygonal prism formed by translating the mesh inwardly of the three-dimensional model is sliced by a slice plane in a predetermined direction; and
setting a color of the colored area set by the area setting unit to a color of the mesh.
